(19) United States
(12) Patent Application Publication
(10) Pub. No.: US 2023/0412449 A1
(43) Pub. Date: Dec. 21, 2023

(54) NETWORK ALERT DETECTION UTILIZING TRAINED EDGE CLASSIFICATION MODELS

(71) Applicant: Hewlett Packard Enterprise Development LP, Houston, TX (US)

(72) Inventors: Kalapriya Kannan, Bangalore (IN); Jayasankar Nallasamy, Bangalore (IN); Chirag Talreja, Bangalore (IN); Pruthvi Raju, Bangalore (IN); Rohini Raghuwanshi, Bangalore (IN)

(21) Appl. No.: 17/836,551

(22) Filed: Jun. 9, 2022

(51) Int. Cl. H04L 41/0604; H04L 41/16; H04L 41/069; H04L 41/0893

(52) U.S. Cl. CPC H04L 41/0618; H04L 41/16; H04L 41/0893; H04L 41/069; H04L 41/0613

(57) ABSTRACT

Network alert detection utilizing trained edge classification models is described. An example of a computing system includes a processor and a memory storing instructions that cause the processor to train one or more classification models at a core for detection of signatures based on training data derived from a set of error codes; deploy the one or more trained classification models at an edge of a network; receive alerts from one or more nodes in one or more clusters of nodes in the network; detect one or more signatures by processing the received alerts at the one or more trained classification models; and perform one or more actions to address a signature that is detected by the one or more trained classification models.

### BACKGROUND

In a cloud environment serving multiple clusters of nodes (such as storage nodes), the nodes may generate large numbers of constantly flowing alerts, where the alerts are triggered in response to various conditions and may indicate many different types of issues in operations. There may be a wide range of configurations, models, and releases associated with the clusters of nodes, resulting in generation of many different types of alerts. In such a cloud environment, signatures comprising one or more alerts that are received from the nodes are detected in order to allow the system to identify and respond to the issues that have developed.

However, there is increasing pressure to maintain the operations of cloud environments, which requires that detection of signatures be performed quickly so that the underlying issues can be identified and corrected. Conventional alert detection technologies, which commonly utilize rules that are applied in core processing for detection, necessitate the transfer of the large amounts of alert data to the core for analysis. Such technologies thus may not provide sufficient performance in identifying signatures that are representative of the received alerts, particularly as the number of alerts and the amount of alert data to be transferred for core processing scales upward in expanding cloud systems.

### BRIEF DESCRIPTION OF THE DRAWINGS

Examples described here are illustrated by way of example, and not by way of limitation, in the figures of the accompanying drawings in which like reference numerals refer to similar elements.

FIG. 1 is an illustration of alert detection in a network, according to some examples;

FIG. 2A is an illustration of deployment of elements to provide network alert detection with trained edge classification models, according to some examples;

FIG. 2B is an illustration of a system architecture to provide network alert detection with trained edge classification models, according to some examples;

FIG. 3A is an illustration of signatures representing one or more alerts from a single node, according to some examples;

FIG. 3B is an illustration of signatures representing multiple alerts from multiple nodes, according to some examples;

FIG. 4 is an illustration of one or more trained classification models deployed for detection of signatures representing one or more alerts from nodes, according to some examples;

FIG. 5 is an illustration of generation of training data for training of classification models for detection of signatures representing one or more alerts from nodes, according to some examples;

FIG. 6 is a flowchart to illustrate a process for network alert detection using trained edge classification, according to some examples; and

FIG. 7 depicts an example system to provide for network alert detection using trained edge classification, according to some examples.

### DETAILED DESCRIPTION

In a cloud environment, alerts that generated by nodes in a customer install base are recorded, and the alerts (which may also be referred to as events) are streamed for analysis. An alert refers to a communication containing information, wherein the information may include error codes, corresponding messages relating to the error codes or any other relevant information. Alerts are triggered in response to multiple different types of conditions occurring relating to a node. A condition may include, for example, a particular failure or other type of issue relating to a node. Examples of conditions that may trigger alerts may include response time delays, high processor or memory usage, device failures or outages, loss of server connectivity, and numerous others in relation to nodes. It is noted that in some operations alerts may also be generated to provide information in response to, for example, normal conditions or statuses. As used herein, node refers to any device or system within a network, and may include a storage node, a compute node, or other type of node within the network. Nodes may be configured into clusters, such as in, for example, datacenter configurations. As used herein, cluster refers to any grouping of nodes.

Each node in a cloud system will independently generate alerts in response to the node encountering various conditions. The alerts may be logged into respective log files associated with each node, and may be further converted into a file structure (including one or more headers which may indicate a time stamp, a node name, severity of the condition, or any other information) to be streamed from the node to the cloud.

With potentially millions of alerts generated by nodes flowing constantly in a large system, there is a significant challenge in identifying signatures within the alert data. A signature represents a certain pattern of one or more alerts that have been received or obtained within a network. A signature is representative of a particular issue or issues, such as, for example, system failures, overburdened elements, or losses in communication channels, that have occurred within a system. The one or more alerts represented by a signature, may vary in kind and scope, and may be related to more than one node within a system. For example, one or more alerts may be generated in connection with a particular node due to, for example, a failure of a single component or multiple subcomponents of the node, or may be generated due to multiple nodes exhibiting particular conditions that are indicative of issues within the system. Issues related to multiple nodes may include, for example, multiple nodes having response delay problems that are indicative of a larger problem within the system.

Resources in the cloud environment that are provisioned to provide compute and data storage services to clients require constant monitoring and calibration to ensure proper operation and to handle any failure or other issue that occurs. For this reason, there is increasing pressure to provide rapid and accurate detection of signatures that are representative of alerts that have been generated by nodes in a cloud environment to allow the system to recognize and address the underlying issues and maintain continued, stable operations for clients.

However, existing detection technologies, which generally rely on rule-based detection, do not scale well with increasing numbers of alerts generated by nodes. In such existing detection technologies, log data for alerts is collected from a customer install base, transferred to a core in the cloud environment, and processed utilizing a rule based engine to detect signatures in the alert data. As used herein, a cloud environment refers to an infrastructure of hardware and software that is used to create, index, store, and share large amounts of data from multiple users and locations. As used herein, the core in a cloud environment refers to a centralized cloud infrastructure, or a portion of such infrastructure, that provides services and support for the cloud. The core may include one or more servers to provide management and processing of cloud data, storage for cloud data, and other hardware to provide cloud services. The cloud storage may be implemented in various different forms, including data lake storage that is hosted by the core. A data lake as used herein is a location in a cloud architecture that holds large amounts of data in a raw, native format. Native format refers to data that remains in a format of the system or application that created the data.

The volume of alerts that are generated in a particular cloud environment may be in the range of millions of alerts, and the signatures representing such alerts may range from single-alert patterns to multi-alert patterns involving streams of alerts from multiple nodes, wherein the nodes may be contained in different locations within a network architecture.

Increases in the volume of alerts in a network have generally been addressed through over-provisioning of expensive computation, network, and storage elements, and through application of large amounts of human effort. Applying existing techniques using core processing of alerts results in operational limitations due to delays in network transfer, limited availability of computation cycles, expensive IO operations to store alert data, potential failure of computing nodes, and other factors. Applying existing techniques will be complicated by the occurrence of issues such as delays in network transmission. Such existing detection operations are very expensive in terms of system capacity to transfer the needed volume of alert data via limited capacity networks, and impose significant challenges to meet mandated time bounds for issue detection. Further, the performance of rule-based systems exhibits a linear proportionality to the number of signatures present, and therefore even a small increase in signatures can greatly impact detection performance.

In some examples of the current disclosure, in contrast with existing technologies, a system provides network alert detection utilizing trained edge classification models. As used herein, trained edge classification models are trained classification models that are deployed on a network edge. A network edge refers to a device or location in a network that interfaces with another network or networks, and thus near to the network nodes that are generating alerts. As used herein, classification models are models that produce a classification result based on data input. Classification models include neural network models that may be trained using machine learning techniques, wherein the trained classification model may perform inference processing to generate classification results. In this disclosure, an edge classification technology provides that one or more classification models are trained at a core, and then are deployed at a network edge to perform signature detection. In this manner, the system is not required to transfer the large amounts of received alert data to the core for processing because, in contrast with rule-based detection that utilizes core processing, the detection operation is performed at the network edge.

The placement of classification models at a network edge positions the signature detection as close as possible to the origin of the received alerts, and allows for minimizing delays in receiving and analyzing alerts to detect signatures. Edge deployment avoids transfer, storage, and processing of data at a central infrastructure, allowing for enhancement in performance in signature detection. The edge deployment may also be used to ensure that signature sequence ordering and detection of a signature is completed within a specified time window because delays in receiving alerts are minimized. Specified time window as used herein refers to a time window that is required for detection, or that is otherwise applied in a system. Such classification models may be implemented or maintained with reduced software rebuilding burden for clients as the deployment is limited to smaller models that are positioned at the network edge. Further, edge deployment of the models may be performed utilizing software defined channels, thereby reducing the costs associated with data transfer for the models.

In some examples of the current disclosure, a system may implement multiple different trained classification models to further enhance detection performance while simplifying training and reducing model complexity. The multiple classification models may detect different sets of signatures (such as sets of signatures representing single or multiple alerts, where alerts may originate from one or more nodes). The deployment of multiple classification models reduces the complexity of model training as the number of signatures to be addressed by each classification model is reduced, as well as allowing for training and deployment of lightweight and manageable classification models at a network edge to further simplify implementation and maintenance of signature detection capabilities. One or more classification models may employ different learning inferences to identify different categories of signatures that are indicative of issues (such as different types of failures or conditions of concern, as defined above) at different stages within the edge architecture (such as issues at a cluster stage, datacenter stage, or any other stage) as applicable for each stage. For example, certain issues may occur or be of concern in relation to a cluster of nodes, and other issues may occur or be of concern in relation to a datacenter, and classification models may be trained to reflect these separate issues.

In some examples in the current disclosure, training of classification models may be performed based on training data generated from error codes. Signature patterns are derived from these error codes and corresponding messages contained in alerts as the error codes and messages show the nature of the underlying conditions that the alerts represent, and these conditions are used to determine signatures to be detected. For example, a signature relating to memory limitations in a system may represent alerts that contain error codes relating to memory limitations that are encountered by one or more nodes. Data for training may be generated during the process of developing code using, for example, software repositories where errors are coded, triage nodes identifying issues software testing, and root cause analysis in which root causes of defects are identified. The training based on the generated data thus may be performed without transfer of alert data to the core.

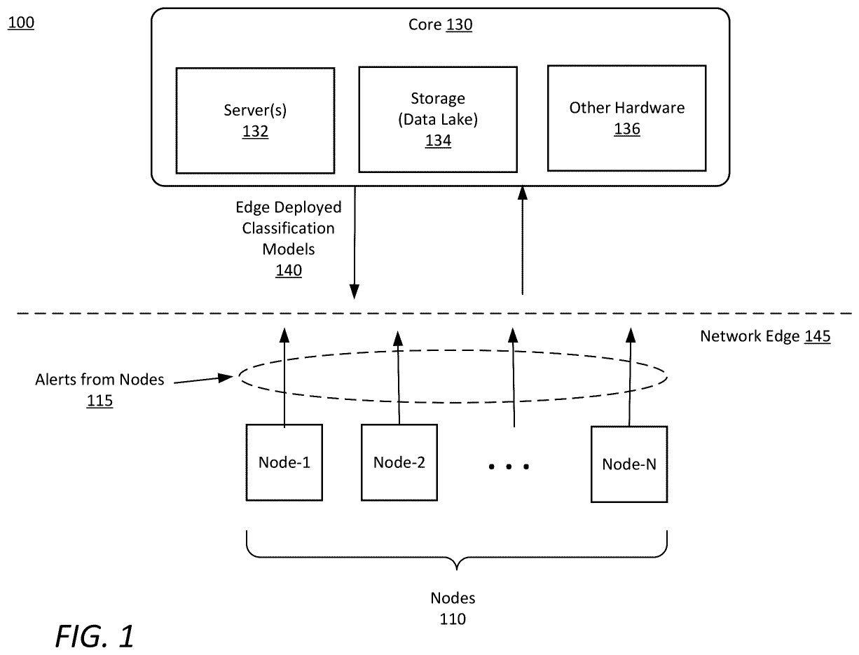

FIG. 1 is an illustration of alert detection in a network, according to some examples. As illustrated in FIG. 1, a system 100 may include multiple nodes 110 (which may also be referred to as client nodes), illustrated as Node-1, Node-2, and continuing through Node-N, where N may be any number. Such nodes may be included within one or more clusters of nodes in the system 100. A node of the multiple nodes 110 may generate alerts 115 upon the occurrence of any issues associated with the node. With growing numbers of nodes within cloud environments, a large number of alerts may be produced by the nodes 110 in response to issues, such as failures and other conditions that are occurring in relation to each of such nodes. A failure may include, for example, failures of particular hardware elements or communication channels within a system. Conditions that occur may include, for example, limitations in processing or memory capacity that are encountered by one or more nodes. Also illustrated is a core 130 within the system 100, the core being a centralized cloud infrastructure to provide services and support. The core 130 may include one or more servers 132 to provide management and processing of cloud data, storage 134 such as a data lake for cloud data, and other hardware 136 to provide cloud services.

In order to identify and address issues that have arisen with regard to the nodes 110, the system 100 may provide for detection of signatures that represent one or more of the alerts through implementation of classification models that are deployed at a network edge, where the classification models may run on one or more of the nodes 110. Alerts may be received from a single node, where a single log subsystem within the node contains alerts. In another example, alerts may originate from a single node but relate to multiple log subsystems within the node, with each such log subsystem containing alerts. As used here, a log subsystem refers to a subsystem to generate a log containing a record of activity, wherein the activity may include alerts that are generated by a node. In a further example, multiple alerts originating from multiple nodes may represent issues that affect multiple nodes within a network.

In some examples, alerts may be triggered in connection with a node experiencing a failure of a single or multiple sub-components of the node. Multiple nodes may experience conditions that indicate broader issues in a network (such as a loss of connectivity to a server, unusually high CPU or memory usage, and other such conditions), or other types or patterns of conditions that occur in a network.

In a particular example, a signature regarding low cluster physical capacity represents an alert as provided in Table 1. It is noted that for ease of illustration Table 1 represents a pattern representing a single alert received from a single node, while other signatures may include more complex patterns including multiple alerts from one or more nodes.

TABLE 1
Signature

| Type of | | Usage: |
|---|---|---|
| Signature: | Low Cluster Physical Capacity | Percent Used |
| Alert Represented | CLUSTER PHYSICAL CAPACITY | USAGE: 95% |
| by Signature: | IS DANGEROUSLY LOW | |

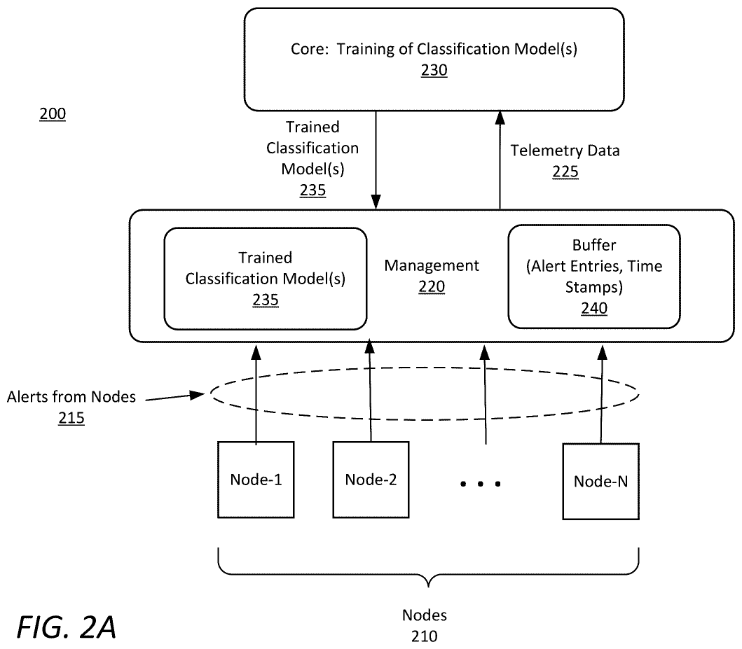

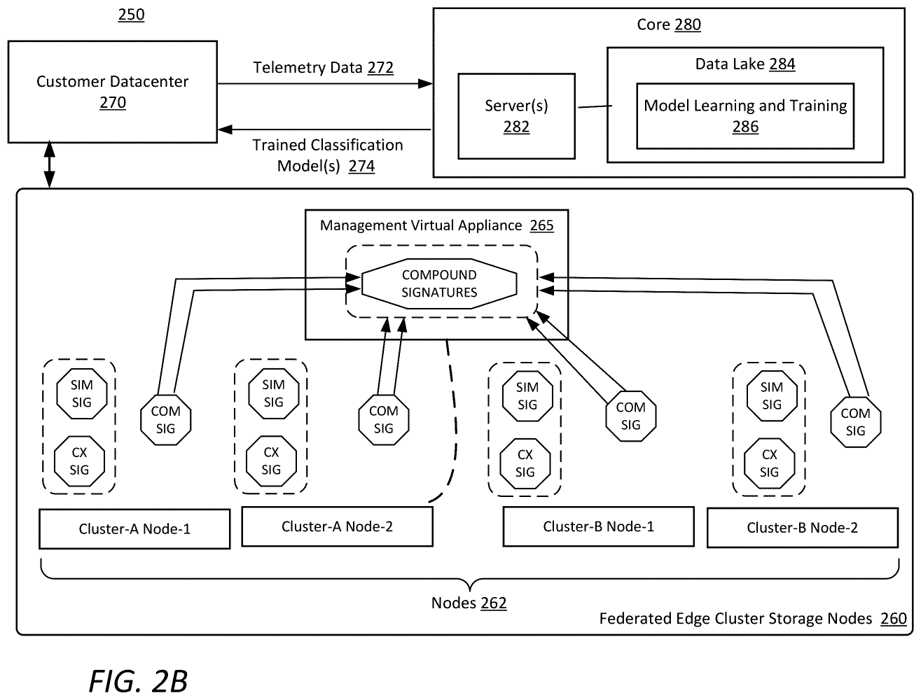

In some examples in the present disclosure, in order to enhance detection performance and minimize the transfer of alert data within the system 100, the architecture of system 100 implements the signature detection at a network edge 145. The network edge 145 is illustrated as a dashed line to denote a location of the network edge, with the nodes 110 being on the network edge side. The signature detection in the present disclosure, rather than utilizing rule-based detection, provides for application of one or more edge deployed classification models 140 at the network edge 145 to detect signatures based on the alerts 115. Training of the one or more classification models may be performed at the core 130 utilizing training data that is generated based on error codes, without requiring the transmission of the alert data to the core for training. Further details may be as illustrated in FIGS. 2A and 2B.

FIG. 2A is an illustration of deployment of elements to provide network alert detection with trained edge classification models, according to some examples. In some examples, a system 200, which is illustrated in a high level view, provides network alert detection using trained edge classification. In the general architecture illustrated in FIG. 2A, system 200 includes an element such as a management element 220, which may include any one or more network apparatuses, to receive alerts 215 from multiple nodes 210, shown as Node-1, Node-2, and continuing through Node-N, wherein N can be any number. Network edge apparatuses may include, for example, elements of a customer datacenter. As used here, customer datacenter refers to one or more facilities containing networked computers, storage systems, and computing infrastructure that are utilized in organizing, processing, storing large amounts of data for customers. The nodes 210 may be within one or more clusters of nodes. The system 200 is to provide for analysis of the received alerts 215 to detect one or more signatures in the alerts.

Signatures represent patterns of alerts from one or more of the nodes 210. For example, a particular signature may represent a single alert from a single node, multiple alerts from a single node, or multiple alerts from multiple different nodes. In circumstances in which there are multiple alerts, a signature may include certain constraints, such as one or more of a timing constraint (referring to a constraint on a time period during which the alerts are, for example, received or sent) or an ordering constraint (referring to a constraint on an order in which alerts are, for example, transmitted or received).

As used herein, “simple signatures” are composed of single alerts from a single node (such as from a single sub-component of the node, and typically reflecting a single log file) and that directly reflect an issue, which may represent a critical issue for a node in some examples. An example of a simple signature would be a single alert triggered in response to a disk failure in a node. As used herein, “complex signatures” are composed of multiple events (which may be relate to multiple sub-components and therefore different log files) from the same node. As used herein, “compound signatures” are composed of multiple events (which may, for example, reflect multiple single log files) from different nodes. In some examples, a simple classification model may be applied to categorize a signature into a particular category for detection analysis, such as a simple, complex, or compound signature. In some examples, the categories of signatures may determine the placement of the classification models based on the alert visibility that is exposed.

It is noted that, while signatures are generally described herein as simple, complex, and compound signatures, other classifications of signatures are possible, and such classifications may be used to distinguish between detected signatures in detection operations.

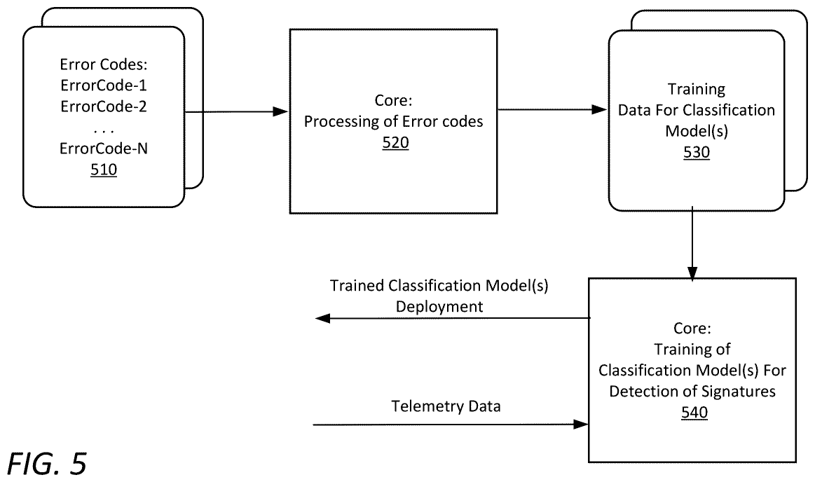

In some examples, the system 200 includes a core 230. Training is performed at the core using training data. The data is generated based on error codes, rather than using received alerts as samples. Following the training, the trained classification models are deployed at the network edge, where the models ingest alert date directly without the transfer of alert data to the core 230. One example of training of classification models is illustrated in FIG. 5.

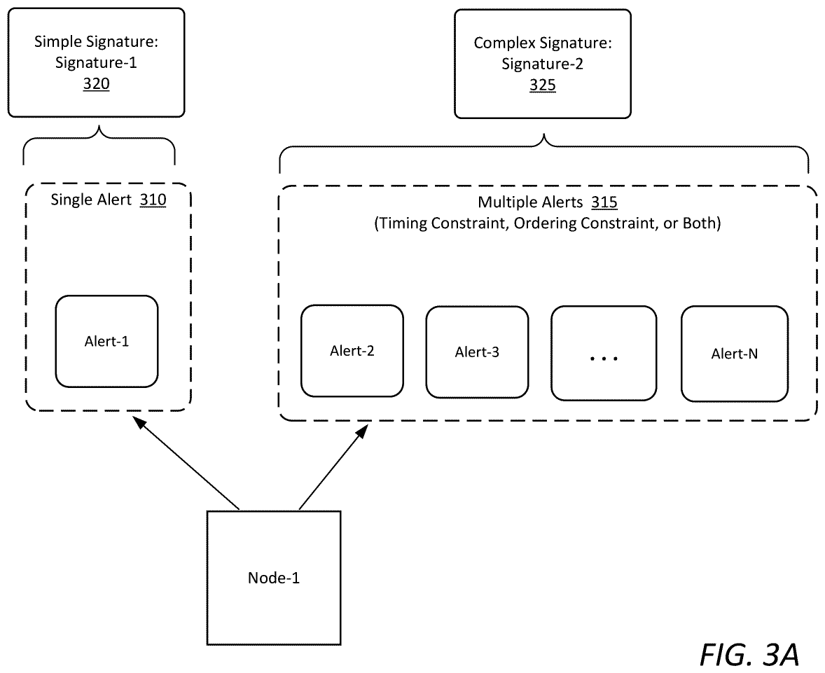

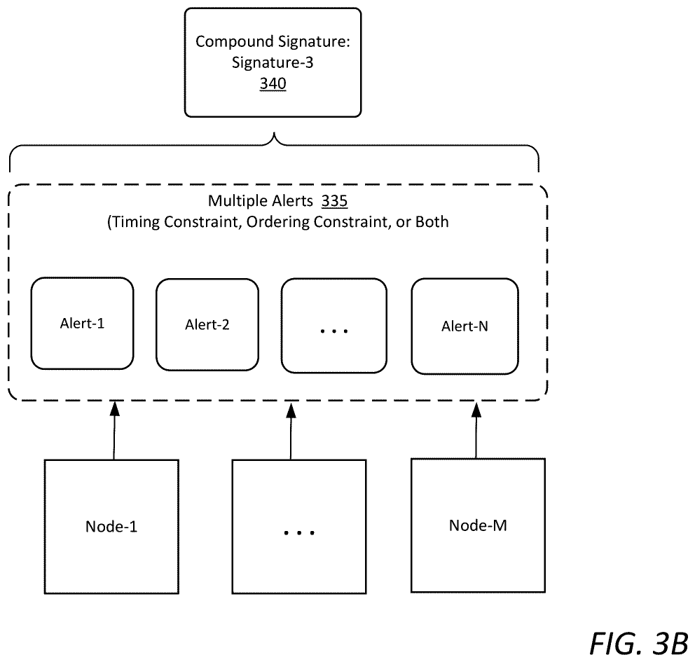

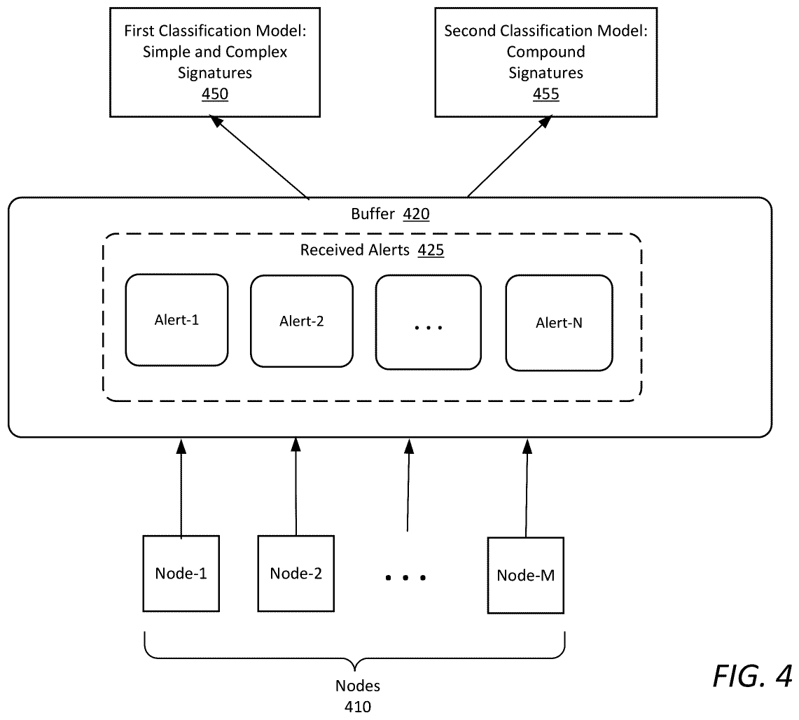

In some examples, one or more trained classification models 235 may be deployed at the edge of the network for use in detecting signatures in the alerts 215 received or obtained from the nodes 210. The edge classification models thus being deployed at the edge with the nodes that are generating the alerts as the network edge is the nearest location to the nodes. An example of detected signatures is illustrated in FIGS. 3A and 3B. In some examples, the one or more classification models are deployed on one or more virtual machines on one or more nodes 210 to provide detection in the system 200, An example of one or more trained classification models is illustrated in FIG. 4.

In some examples, the system 200 may further provide for generation of limited telemetry data 225 that is related to the received alerts and detected signatures. The telemetry data 225 may be directed to the core 230 for continued training operation, thus creating a feedback loop to provide improved training of the one or more classification models.

In some examples in the current disclosure, the system 200 further includes a buffer 240, wherein the buffer 240 holds a certain number of alerts that have been generated by the nodes. As used here, a buffer is a region in memory that temporarily stores data, including storage of data prior to use or transfer of such data. The alert entries stored in buffer 240 may be obtained and used in detection of signatures by the one or more trained classification models 235. The buffer 240 may include further information related to the alert entries, such as time stamps that reflect a time, e.g. a generation time or receipt time, associated with the alerts. The time stamps may be used in connection with detecting signatures having one or more constraints, such as time constraints and ordering constraints. It is noted that the buffer 240, which may store alerts as such alerts are received, may also store one or more alerts that are not related to signatures that are being detected by the one or more classification models.

FIG. 2B is an illustration of a system architecture to provide network alert detection with trained edge classification models, according to some examples. In an example, a system 250 provides network alert detection using trained edge classification. The system 250 includes federated edge cluster storage nodes 260, wherein the nodes 262 in this illustration include nodes in a first cluster (Cluster-A Node-1 and Cluster-A Node-2), nodes in a second cluster (Cluster-B Node-1 and Cluster-B Node-2), and may further include nodes in any additional cluster or clusters in the system 250. In general, federated storage refers to a collection of autonomous storage resources governed by a common management system that provides rules concerning how data is stored, managed, and migrated in the storage network. It is noted that the nodes 262 provide a particular implementation, and examples are not limited to this implementation, and may be structured differently in different implementations.

Further illustrated in FIG. 2B is customer datacenter 270 and a management virtual appliance 265 that is deployed through the customer datacenter 270 to provide management for the nodes 262, wherein the management virtual appliance 265 is visible to the nodes 262, where being visible refers to the management virtual appliance 265 being detectable by the nodes. As used here, customer datacenter refers to one or more facilities containing networked computers, storage systems, and computing infrastructure that are utilized in organizing, processing, storing large amounts of data for customers. The management virtual appliance 265 is a special system virtual machine which may be running in any one or more of the nodes 262. In an example, the management virtual appliance 265 is illustrated as running in Cluster-A, Node-2. Because the management virtual appliance 265 is a system owned virtual machine, the appliance has a capability to manage multiple nodes, such as each of the nodes 262. The capability of the management virtual appliance 265 to access such nodes includes access in systems in which nodes 262 are logically grouped as one or more clusters, as illustrated in FIG. 2B.

The generation of training data and the training of the one or more classification models is performed in a core 280 of the system 250. The core 280 may include, but is not limited to, one or more servers 282 and a data lake 284 that is hosted in the core 280. The servers 282 provide model learning and training block 286 in the data lake 284 to generate one or more trained classification models 274, which are to be deployed at, for example, the customer datacenter 270. The customer datacenter 270 may further return telemetry data for continued training operation. The servers 282 operate to prepare training data for training of the one or more trained classification models 274, including collating and analyzing incoming telemetry data 272 to further improve the models.

The nodes may generate multiple alerts in response to conditions related to the nodes. The one or more trained classification models may be utilized to detect signatures that represent one or more alerts received from the nodes 262. As illustrated in FIG. 2B, detected signatures may represent one or more alerts that are generated by a single node, such as the simple signatures (SIM SIG) and complex signatures (CX SIG) illustrated for the nodes 262, and compound signatures (COM SIG) representing multiple alerts from multiple nodes. In an example, the one or more trained classification models may include a first classification model that runs on individual nodes of the nodes 262, where the first classification model provides for detection of simple signatures and complex signatures for the individual nodes. Further, the one or more trained classification models may include a second classification model that runs on the management virtual appliance 265 on a single node of the nodes 262 (the single node being, for example, Cluster-A, Node-2 in FIG. 2B), where the first classification model provides for detection of compound signatures for multiple nodes.

FIG. 3A is an illustration of signatures representing one or more alerts from a single node, according to some examples. As illustrated in FIG. 3A, alerts from a single node, such as Node-1 (wherein Node-1 is one of any number of nodes in a system), may include a single alert 310 (shown as Alert-1), which may relate to a single sub-component of Node-1. Alerts from Node-1 may also include a certain set of multiple alerts 315, which in this illustration are Alert-2, Alert-3, and continuing through Alert-N (wherein N may be any number), where the multiple alerts 315 may include any number of two or more alerts, which may relate to multiple sub-components of Node-1.

In the illustrated example, detection of a simple signature designated as Signature-1 320 represents receipt of Alert-1 from Node-1, where the single alert relates to an issue in Node-1. In addition, detection of a particular complex signature designated as Signature-2 325 represents receipt of Alert-2, Alert-3, and continuing through Alert-N from Node 1. Signature-2 may further include one or more constraints on the received alerts. For example, the one or more constraints may include one or more of a timing constraint, such as a requirement that Alert-2 through Alert-N are generated or received within a certain period of time, or an ordering constraint, such as a requirement that Alert-2 be generated or received prior to Alert-3, etc. (or any other constraint regarding order of the multiple alerts).

FIG. 3B is an illustration of signatures representing multiple alerts from multiple nodes, according to some examples. As illustrated in FIG. 3A, alerts from set of nodes, such as Node-1 through Node-M (where M may be any number of 2 or more), may include a certain set of multiple alerts 335 (shown as Alert-1, Alert-2, and continuing through Alert-N, where N may be any number), which may relate to one or more sub-components of the nodes within Node-1 through Node-M.

In the illustrated example, detection of a compound signature designated as Signature-3 340 represents receipt of Alert-1 through Alert-N from Node-1 through Node-M. For example, the alerts may relate to a particular type of alert that is received from one of Node-1 through Node-M, multiple alerts of multiple types from Node-1 through Node-M, or another combination of alerts from the nodes. Signature-3 340 may further include one or more constraints on the received alerts, wherein the one or more constraints may, for example, include one or more of a timing constraint, such as a requirement that Alert-1 through Alert-N are generated or received within a certain period of time, or an ordering constraint, such as a requirement that Alert-1 be generated or received prior to Alert-2, etc. (or any other constraint regarding order of the multiple alerts).

In some examples, entries for any of the single alert 310 in FIG. 3A, the multiple alerts 315 in FIG. 3A, or the multiple alerts 335 in FIG. 3B may be stored in a buffer for detection. An example of a buffer is illustrated in FIG. 2A.

Specific examples of simple, complex, and compound signatures in a particular platform (i.e. HPE SimpliVity) may include examples as provided in Table 2. However, signatures are not limited to these examples, or to examples related to any particular platform.

TABLE 2
Example Signatures

| Signature Type | | Description |
|---|---|---|
| Simple | 1 | Phonehome-Eventmgr is not connected to this system. |
| | | Severity Level: PHONE_RED; System Serial Number: |
| | | xxxxxxxx; Source IP: xxxxxx; vCenter Version: VMware |
| | | vCenter Server xxx build xxxxxx; Virtual Controller SW |
| | | Version: Release xxxxx; Arbiter Version Release xxxx; |
| | | Model: xxxxxx Series xxxx |
| | 2 | Storage High Availability protection lost for vcenter1_1 on |
| | | datastore xxxxx |
| Complex | 1 | There are 8 drives faulted in one logical device |
| | 2 | Physical drive in location: xx is missing. |
| | 3 | Read of Object from ssd at offset xxxxxx failed with status - 8. |
| Compound | 1 | System {node} in the cluster is unreachable. VMs may stop |
| | | and become inactive if additional systems become |
| | | unreachable. |

FIG. 4 is an illustration of one or more trained classification models deployed for detection of signatures representing one or more alerts from nodes, according to some examples. As illustrated in FIG. 4, alerts 425 from one or more nodes, such as Node-1 through Node-M (where M may be any number) may be received in a network. The received alerts 425 may in some examples be stored in a buffer 420 for detection of signatures. In some examples, a system provides for deployment of one or more trained classification models at an edge of the network to provide for detection of signatures representing one or more alerts in the received alerts 425.

In an example, the one or more trained classification models include a first classification model 450 that is trained for detection of simple signatures that represent a single alert from a single node of the nodes 410 (such as Alert-1 from Node-1, or any other such example), and detection of complex signatures that represent multiple alerts from a single node of the nodes 410 (such as Alert-1 and Alert-2 from Node-1, or any other such example). In the example, the one or more trained classification models further include a second classification model 455 that is trained for detection of compound signatures that represent multiple alerts from multiple nodes of the nodes 410 (such as Alert-1 and Alert-2 from Node-1 and Node-2, or any other such example).

While a certain set of multiple trained classification models may include the first classification model 450 and the second classification model 455, examples are not limited to a set of first and second trained classification models. In a particular example, a set of multiple trained classifications models may alternatively include a first classification model to detect simple signatures, a second classification model to detect complex signatures, and a third classification model to detect compound signatures.

FIG. 5 is an illustration of generation of training data for training of classification models for detection of signatures representing one or more alerts from nodes, according to some examples. As illustrated in FIG. 5, a set of error codes 510, such as a certain set of error codes ErrorCode-1 through ErrorCode-N representing issues that may occur in nodes in a network, are received by the core for processing of the error codes 520 in order to generate training data (also referred to as samples, or training samples) for one or more classification models 530.

In some examples, the error codes 510 may include multiple different sets of error codes to generate separate sets of training data for the one or more classification models. For example, in a network in which, for example, a first classification model is trained for detection of simple and complex signatures from single nodes and a second classification model is trained for detection of compound signatures from a set of nodes, the error codes 510 may include multiple sets of error codes that reflect the issues arising for a single node and issues arising for multiple nodes. In this example, the multiple sets of error codes include a first set of error codes for generation of a first set of training data for training of the first classification model, and a second set of error codes for generation of a second set of training data for training of the second classification model.

In some examples, the training data 530 may be generated with relevant alerts as features. A training data sample may have as many features as the number of alerts that are represented by a signature. Further, constraints (such as timing constraints and ordering constraints) may be included as additional features in training data samples. In an example, a timing constraint for alerts represented by a signature may be represented as an additional feature, with the feature being a particular value or range for the timing constraint. Constraints may be represented by, for example, a numerical expression, such as a range, one or more threshold values, or other values. For example, a constraint of “within 5 minutes” may be represented as [0-5] (or any other representation of the time constraints), with five events being represented as five samples, an event having one of the time values.

The generated training data 530 is utilized by the core for training of the classification models 540. The model training is performed at the core in the centralized system, which is closer to, for example, software code repositories, RCA (root cause analysis), support captures, triage notes, and other possible data. The model training is not dependent on samples from the edge, but rather on samples generated from error codes, and patterns are derived from those error codes and corresponding messages. The training is performed for categories of the signatures (for example, simple, complex, and compound signatures) at the core, which may include application of a profiling tool (e.g. a tool for analyzing code) of the relevant software source code.

The trained edge classification models may then be deployed for detection of signatures. In some examples, the core 540 may further receive certain limited telemetry data regarding model detection operation to generate a feedback loop to improve the training of classification models.

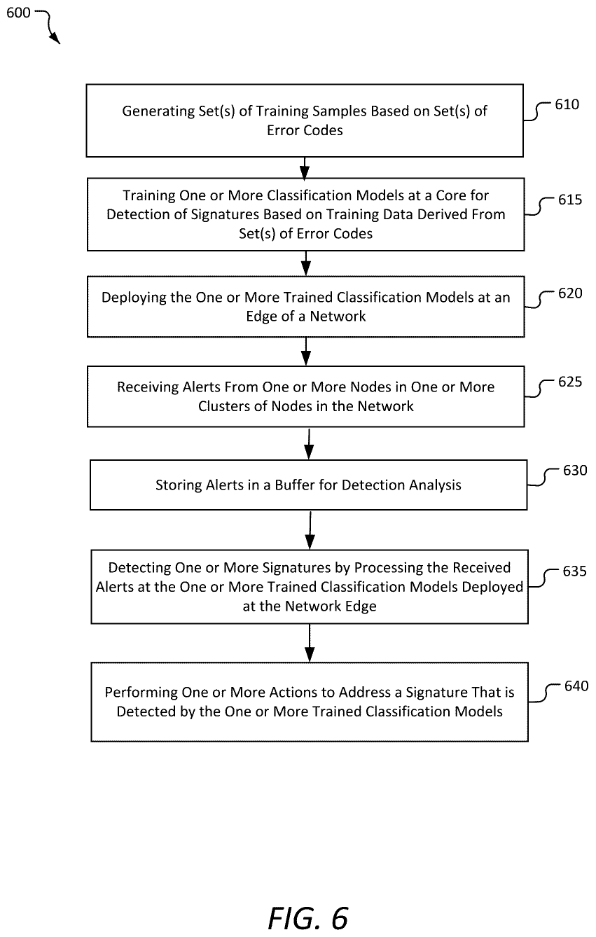

FIG. 6 is a flowchart to illustrate a process for network alert detection using trained edge classification, according to some examples. In some examples, a process 600 includes generating one or more sets of training data based on one or more sets of error codes 610. The generation of the training data based on the error codes may be utilized to avoid the need to transfer large quantities of alert data from nodes to a core for training of classification models. Generating the one or more sets of training data may include, for example, generating a first set of training data based on a first set of error codes and generating a second set of training data based on a second set of error codes.

In some examples, the process 600 further includes training one or more classification models at a core for detection of signatures based on the training data derived from the one or more sets of error codes 615. The training of the one or more classification models may be performed at a core, and the use of the training data derived from error data enables performance of the training without requiring receipt and use of received alerts from one or more nodes.

The training may include training of multiple classification models, such as a first classification model to detect one or more signatures comprising one or more alerts from a single node within one or more clusters of nodes and a second classification model to detect one or more signatures comprising alerts from a set of nodes within the one or more clusters of nodes. The one or more signatures detected by the first classification model may comprise at least one of a simple signature representing a single alert from the single node or a complex signature representing a plurality of alerts from the single node, and the one or more signatures detected by the second classification model may comprise a compound signature representing a plurality of alerts from the set of nodes in the one or more clusters of nodes.

In some examples, the training may include training the first classification model based on a first set of training data and training the second classification model based on a second set of training data. In an example, the first classification model may be trained to detect one or more signatures that include one or more alerts from a single node within one or more clusters of nodes, and the second classification model may be trained to detect multiple signatures that include alerts from multiple nodes within the one or more clusters of nodes. The training of the classification models may further include creation of a feedback loop by generating a set of telemetry data based on the received alerts and transferring the set of telemetry data to the core for use in training.

The process 600 further includes deploying the one or more trained classification models at an edge of a network 620, and receiving alerts from the one or more nodes in the one or more clusters of nodes in the network 625. Deploying the one or more trained classification models may include deploying the one or more classification models utilizing a virtual management unit, wherein the virtual management unit is configured to be visible to the nodes. As used herein, visible refers to the virtual management unit being detectable by a node.

In some examples, the alerts may be stored in a buffer for detection analysis 630. The process may include detecting signatures based on alerts stored in the buffer that that are received from a single node or from multiple nodes within one or more clusters of nodes. The storage of the alerts may include the storage of time stamps associated with the received alerts, which may be utilized in detection of certain signatures. In some examples, the storage of alerts may include the storage of a certain number of alerts, where alerts that are removed as additional alerts are received. For example, older alerts may be removed as newer alerts are received, or lower priority alerts may be removed as higher priority alerts are received.

In some examples, one or more signatures are detected by processing the received alerts at the one or more trained classification models deployed at the network edge 635. The received alerts may be processed by the one or more trained classification models without forwarding the alerts to the core. The detection of signatures may include detection of one or more of a simple signature representing a single alert from a single node; a complex signature representing a plurality of alerts from the single node; or a compound signature representing multiple alerts from multiple nodes. In some examples, certain alerts may be forwarded to the core, while others are not. In a specific example, certain alerts, such as alerts that relate to complex signatures, compound signatures, or both, may be forwarded to the core. Further in this example, other alerts, such as alerts that relate to simple signatures, may not be forwarded to the core. One or more classification models may be trained to determine which alerts are to be forwarded to the core and which are not.

The detection may include analysis of alerts that are stored in the buffer. Detection of complex or compound signatures may include use of stored time stamps associated with the alerts in detection of signatures including timing or ordering constraints for the alerts of the signature.

The process 600 may further include performing one or more actions to address a signature that is detected by the one or more trained classification models 640, where the specific actions are dependent on the type of signatures that are detected. In an example, upon detection of a signature indicating a failure of a component, the action taken may include action to support failover or other process to handle the failure. In another example, upon detection of a signature indicating very low physical capacity in a cluster, the action taken may include action reduce usage or expand capacity in the cluster.

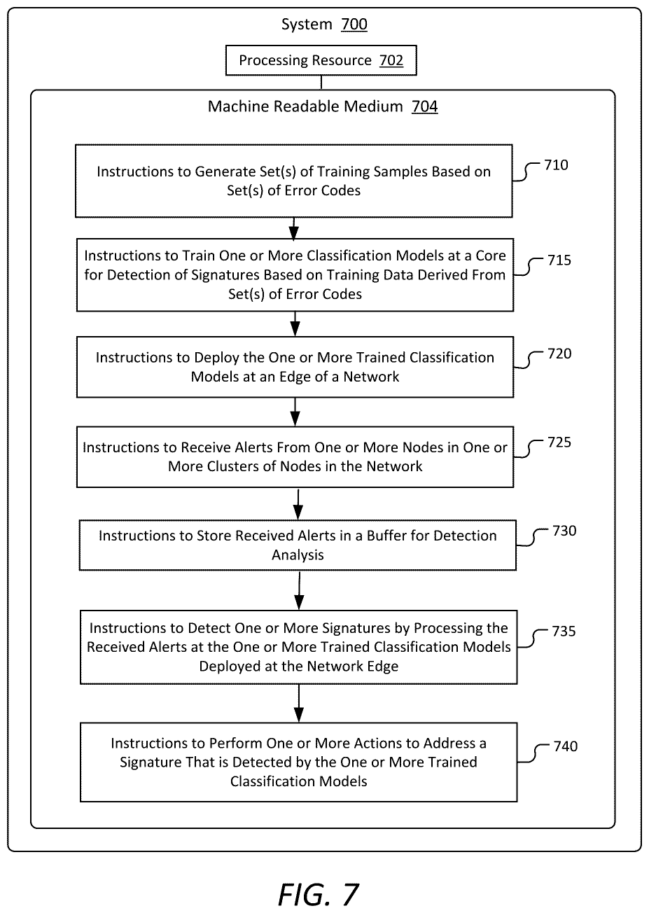

FIG. 7 depicts an example system to provide for network alert detection using trained edge classification, according to some examples. An example system 700 includes a non-transitory, machine readable medium 704 encoded with example instructions 710, 715, 720, 725, 730, 735, and 740 (collectively referred to as instructions 710-740) executable by a processing resource 702. In some implementations, the system 700 may be useful for performing the process illustrated in FIG. 6.

The processing resource 702 may include a microcontroller, a microprocessor, central processing unit core(s), an ASIC (Application-Specific Integrated Circuit), an FPGA (Field-Programmable Gate Array), and/or other hardware device suitable for retrieval and/or execution of instructions from the machine readable medium 704 to perform functions related to various examples. Additionally or alternatively, the processing resource 702 may include or be coupled to electronic circuitry or dedicated logic for performing the functionality of the instructions or some part of the functionality of the instructions.

The machine readable medium 704 may be any medium suitable for storing executable instructions, such as RAM (Random-Access Memory), ROM (Read-Only Memory), EEPROM (Electrically Erasable Programmable Read-Only Memory), flash memory, a hard disk drive, an optical disc, or the like. In some example implementations, the machine readable medium 704 may be a tangible, non-transitory medium. The machine readable medium 704 may be disposed within the system 700, in which case the executable instructions may be deemed installed or embedded on the system 700. Alternatively, the machine readable medium 704 may be a portable (e.g., external) storage medium, and may be part of an installation package.

As described further herein below, the machine readable medium 704 may be encoded with a set of executable instructions 710-740. It should be understood that the executable instructions and/or electronic circuits or a part thereof included within one box may, in alternate implementations, be included in a different box shown in the figures or in a different box not shown. Some implementations of the system 700 may include more or fewer instructions than are shown in FIG. 7.

Instructions 710, when executed, cause the processing resource 702 to generate one or more sets of training samples based on one or more sets of error codes. Generating the one or more sets of training data may include, for example, generating a first set of training data based on a first set of error codes and generating a second set of training data based on a second set of error codes.

Instructions 715, when executed, cause the processing resource 702 to train one or more classification models at a core for detection of signatures based on the training data derived from the one or more sets of error codes. The training of the one or more classification models may be performed at a core, and the use of the training data derived from error data enables performance of the training without requiring receipt and use of received alerts from one or more nodes. The training may include training of multiple classification models, such as a first classification model to detect one or more signatures comprising one or more alerts from a single node within one or more clusters of nodes and a second classification model to detect one or more signatures comprising alerts from a set of nodes within the one or more clusters of nodes. The one or more signatures detected by the first classification model may comprise at least one of a simple signature representing a single alert from the single node or a complex signature representing a plurality of alerts from the single node, and the one or more signatures detected by the second classification model may comprise a compound signature representing a plurality of alerts from the set of nodes in the one or more clusters of nodes. In some examples, the training may include training the first classification model based on a first set of training data and training the second classification model based on a second set of training data. In an example, the first classification model may be trained to detect one or more signatures that include one or more alerts from a single node within one or more clusters of nodes, and the second classification model may be trained to detect multiple signatures that include alerts from multiple nodes within the one or more clusters of nodes. The training of the classification models may further include creation of a feedback loop by generating a set of telemetry data based on the received alerts and transferring the set of telemetry data to the core for use in training.

Instructions 720, when executed, cause the processing resource 702 to deploy the one or more trained classification models at an edge of a network. Deploying the one or more trained classification models may include deploying the one or more classification models utilizing a virtual management unit, wherein the virtual management unit is configured to be visible to the nodes.

Instructions 725, when executed, cause the processing resource 702 to receive alerts from the one or more nodes in the one or more clusters of nodes in the network.

Instructions 730, when executed, cause the processing resource 702 to store received alerts in a buffer for detection analysis. Detection of signatures may be based on alerts stored in the buffer that are received from a single node or from multiple nodes within one or more clusters of nodes. The storage of the alerts may include the storage of time stamps associated with the received alerts, which may be utilized in detection of certain signatures. In some examples, the storage of alerts may include the storage of a certain number of alerts, where alerts that are removed as additional alerts are received.

Instructions 735, when executed, cause the processing resource 702 to detect one or more signatures by processing the received alerts at the one or more trained classification models deployed at the network edge. The received alerts may be processed by the one or more trained classification models without forwarding the alerts to the core. The detection of signatures may include detection of one or more of a simple signature representing a single alert from a single node; a complex signature representing a plurality of alerts from the single node; or a compound signature representing multiple alerts from multiple nodes. The detection may include analysis of alerts stored in the buffer. Detection of complex or compound signatures may include use of stored time stamps associated with the alerts in detection of signatures including timing or ordering constraints for the alerts of the signature.

Instructions 740, when executed, cause the processing resource 702 to perform one or more actions to address a signature that is detected by the one or more trained classification models, where the specific actions are dependent on the type of signatures that are detected.

The following clauses pertain to further examples. Specifics may be applied anywhere in one or more examples. The various features of the different examples may be variously combined with certain features included and others excluded to suit a variety of different applications. Examples may include subject matter such as a method, means for performing acts of the method, at least one machine-readable medium, such as a non-transitory machine-readable medium, including instructions that, when performed by a machine, cause the machine to perform acts of the method, or of an apparatus or system for facilitating operations according to examples described herein.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structure between illustrated components. The components described or illustrated herein may have additional inputs or outputs that are not illustrated or described.

Various examples may include various processes. These processes may be performed by hardware components or may be represented in computer program or machine-executable instructions, which may be used to cause a general-purpose or special-purpose processor or logic circuits programmed with the instructions to perform the processes. Alternatively, the processes may be performed by a combination of hardware and software.

Portions of various examples may be provided as a computer program product, which may include a computer-readable medium having stored thereon computer program instructions, which may be used to program a computer (or other electronic devices) for execution by one or more processors to perform a process according to certain examples. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, examples may also be downloaded as a computer program product, wherein the program may be transferred from a remote computer to a requesting computer. In some examples, a non-transitory computer-readable storage medium has stored thereon data representing sequences of instructions that, when executed by a processor, cause the processor to perform certain operations.

Processes can be added to or deleted from any of the methods described above and information can be added or subtracted from any of the described messages without departing from the basic scope of the present examples. It will be apparent to those skilled in the art that many further modifications and adaptations can be made. The particular examples are not provided to limit the concept but to illustrate it. The scope of the examples is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An example is an implementation. Reference in the specification to “an example,” “one example,” “some examples,” or “other examples” means that a particular feature, structure, or characteristic described in connection with the examples is included in at least some examples, but not necessarily all examples. The various appearances of “an example,” “one example,” or “some examples” are not necessarily all referring to the same examples. It should be appreciated that in the foregoing description of examples, various features are sometimes grouped together in a single example, figure, or description thereof for the purpose of streamlining the disclosure and aiding in the understanding of one or more of the various novel aspects. This method of disclosure, however, is not to be interpreted as reflecting an intention that the claimed examples requires more features than are expressly recited in a claim. Rather, as the following claims reflect, novel aspects lie in less than all features of a single foregoing disclosed example. Thus, the claims are hereby expressly incorporated into this description, with a claim standing on its own as a separate example.

1. A computing system comprising:
a processor; and
a memory storing instructions that, when executed by the processor, cause the processor to:
train a plurality of classification models at a core for detection of signatures based on training data derived from a set of error codes, wherein the plurality of classification models comprises at least a first classification model to detect one or more signatures from a single node within one or more clusters of nodes and a second classification model to detect one or more signatures from a set of nodes within the one or more clusters of nodes;
deploy the plurality of trained classification models at an edge of a network by deploying at least one of the plurality of classification models in a virtual machine;
receive alerts from one or more nodes within the one or more clusters of nodes in the network;
detect one or more of the signatures from a single node or a set of nodes within the one or more clusters of nodes by processing the received alerts at the trained first classification model or second classification model of the plurality of trained classification models; and
perform one or more actions to address a signature that is detected by the trained first classification model or second classification model of the plurality of trained classification models.

2. (canceled)

3. The computing system of claim 1, wherein the one or more signatures detected by the first classification model comprise at least one of a simple signature representing a single alert from the single node or a complex signature representing a plurality of alerts from the single node.

4. (canceled)

5. The computing system of claim 1, wherein the one or more signatures detected by the second classification model comprise a compound signature representing a plurality of alerts from the set of nodes in the one or more clusters of nodes.

6. The computing system of claim 1, further comprising:
a buffer; and
wherein the instructions further cause the processor to:
store received alerts in the buffer, and
detect signatures based on one or more alerts stored in the buffer that are received from the single node or from the set of nodes within the one or more clusters of nodes.

7. (canceled)

8. The computing system of claim 7, wherein the virtual management unit is configured to be visible to the nodes within the one or more clusters of nodes.

9. The computing system of claim 1, wherein the received alerts are processed by the trained first classification model or second classification model of the plurality of trained classification models without forwarding the alerts to the core.

10. The computing system of claim 1, wherein the instructions further cause the processor to:
create a feedback loop for training of the classification models by generating a set of telemetry data based on the received alerts and transferring the set of telemetry data to the core for use in training.

11. A method comprising:
generating a set of training samples based on a set of error codes;
training a plurality of classification models at a core for detection of signatures representing patterns of one or more alerts, wherein the training is based at least in part on the generated set of training samples, wherein the plurality of classification models comprises at least a first classification model to detect one or more signatures from a single node within one or more clusters of nodes and a second classification model to detect one or more signatures from a set of nodes within the one or more clusters of nodes;
deploying the plurality of trained classification models at an edge of a network, wherein deploying the plurality of trained classification models comprises deploying at least one of the plurality of classification models in a virtual machine;
receiving one or more alerts from one or more nodes within the one or more clusters of nodes in the network;
detecting one or more of the signatures from a single node or a set of nodes within the one or more clusters of nodes by processing the received one or more alerts at the trained first classification model or second classification model of the plurality of trained classification models; and
performing one or more actions to address a signature upon the signature being detected by the trained first classification model or second classification model of the plurality of trained classification models.

12. (canceled)

13. The method of claim 11, wherein:
the signatures detected by the trained first classification model comprise at least one of a simple signature representing a single alert received from the single node or a complex signature representing a plurality of alerts received from the single node; and
the signatures detected by the trained second-classification model comprise a compound signature representing a plurality of alerts received from the nodes in the set of nodes.

14. The method of claim 13, wherein the complex signature and the compound signature comprise at least one of:
a time constraint for the alerts of the signature; or
an ordering constraint for the alerts of the signature.

15. The method of claim 11, further comprising:
storing received alerts in a buffer; and
detecting signatures based on one or more alerts stored in the buffer that are received from a single node or from a set of nodes within the one or more clusters of nodes.

16. A non-transitory computer-readable storage medium storing instructions that, when executed by a processor, cause the processor to:
train a plurality of classification models at a core for detection of signatures based on training data derived from a set of error codes, the plurality of trained classification models comprising:
a first classification model to detect one or more signatures in one or more alerts from a single node within one or more clusters of nodes, and
a second classification model to detect one or more signatures in a plurality of alerts from a set of nodes within the one or more clusters of nodes, wherein the second classification model is different from the first classification model;
deploy the plurality of trained classification models at an edge of a network, wherein deploying the plurality of trained classification models comprises deploying at least one of the plurality of classification models in a virtual machine;
receive alerts from one or more nodes within the one or more clusters of nodes of the network;
detect one or more of the signatures from the single node by processing the received alerts at the first classification model; and
detect one or more of the signatures from the set of nodes by processing the received alerts at the second-classification model.

17. The non-transitory computer readable storage medium of claim 16, wherein deploying the plurality of trained classification models comprises deploying at least one of the plurality of trained classification models at a management virtual appliance.

18. The non-transitory computer readable storage medium of claim 16, wherein the storage medium further stores instructions that, when executed by the processor, cause the processor to:
perform one or more actions to address a signature that is detected by the first classification model or the second classification model.

19. The non-transitory computer readable storage medium of claim 16, wherein:
the signatures detected by the first classification model comprise at least one of a simple signature representing a single alert from the single node or a complex signature representing a plurality of alerts from the single node; and
the signatures detected by the second classification model comprise a compound signature representing a plurality of alerts from the nodes in the set of nodes.

20. The non-transitory computer readable storage medium of claim 19, wherein the complex signature and the compound signature comprise at least one of:
a time constraint for the alerts of the signature; or
an ordering constraint for the alerts of the signature.

21. The computing system of claim 1, wherein the one or more signatures detected by the first classification model comprise a complex signature representing a plurality of alerts from the single node.

22. The method of claim 13, wherein the complex signature and the compound signature comprise a time constraint defining a constraint on a time period during which the alerts for the signature are received.
